(19) United States
(12) Patent Application Publication
(10) Pub. No.: US 2015/0267079 A1
(43) Pub. Date: Sep. 24, 2015

(54) SUBSTRATE HAVING A SEMITRANSPARENT COATING

(71) Applicant: SCHOTT AG, Mainz (DE)

(72) Inventors: Matthias Bockmeyer, Mainz (DE); Annelie Gabriel, Klein-Winternheim (DE); Andrea Anton, Huffelsheim (DE); Hans-Joachim Schmitt, Ockenheim (DE); Maximilian Kranz, Harxheim (DE); Stephanie Mangold, Mainz (DE)

(21) Appl. No.: 14/730,523

(22) Filed: Jun. 4, 2015

Related U.S. Application Data
(63) Continuation of application No. PCT/EP2013/074724, filed on Nov. 26, 2013.

(30) Foreign Application Priority Data
Dec. 5, 2012 (DE) 10 2012 111 836.1

(51) Int. Cl. C09D 183/06; C08K 3/08

(52) U.S. Cl. CPC C09D 183/06; C08K 3/08; C08K 2003/0843; C08K 2003/085

(57) ABSTRACT

A substrate of glass or glass ceramics having a semitransparent coating is provided. The semitransparent coating has high scratch resistance, good temperature stability, and good adhesion on a sealing layer. The coating material has at least one sol-gel-based matrix, to which colorants are added, and that a polyester-functionalized and/or an epoxy-functionalized silicone resin, such as a polyester-modified silicone resin, is added to the sol-gel-based matrix.

### CROSS REFERENCE TO RELATED APPLICATIONS

This application is a continuation of International Application No. PCT/EP2013/074724 filed Nov. 26, 2013, which claims the benefit under 35 U.S.C. §119(a) of German Patent Application No. 10 2012 111 836.1 filed Dec. 5, 2012, the entire contents of both of which are incorporated herein by reference.

### BACKGROUND

1. Field of the Disclosure

The invention relates to a substrate having a semitransparent coating.

2. Description of Related Art

The present invention describes a coating material that serves for the coating of transparent glass or glass ceramics, more preferably a glass or glass-ceramic cooktop. Therefore, the coating material according to the invention may be a printable material, for example, a screen-printing paste. Coating material in the sense of the invention may also be an overprint adhering to the substrate, for example, the coating itself.

Semitransparent coatings on glass and glass ceramics that can be employed in display regions in cooktops, for example, are known from the prior art. In particular, 7-segment displays, which indicate, for example, the heating level, or characterize by a dot those cooking zones having higher temperatures are used in the field of cooktops.

Since the glass ceramics used for this purpose have knobby structures on the bottom, due to the production process, and thus light is refracted in different ways, the 7-segment display does not provide sufficiently sharp contours.

In recent years, the use of transparent glass ceramics for cooktops has been established based on a variety of possible color perceptions and designs. This glass has no knobby structures on the bottom and thus no light scattering. Transparent glass ceramics, however, have the disadvantage that the components underneath the cooking surface are visible. In order to assure an appropriate opacity, the glass ceramics, as they are known from the prior art, can be provided with a wide variety of coatings. Usually, the glass ceramics are first provided with a coloring layer, and subsequently with a sealing layer.

A semitransparent coating is required in this field, in order to assure the visibility of a display that is accommodated below the cooking surface. A semitransparent coating that assures a sufficient opacity, but transmits the red light, for example, of the 7-segment display, and has no scattering centers in the visible wavelength region is required for this purpose.

Since the semitransparent coating shall be printed on the adjacent composite layer made up of the coloring layer and the sealing layer, and shall fill only the recessed display region, the latter must be compatible, i.e., the semitransparent coating must adhere well to the already printed composite layer.

Semitransparent coatings based on coloring pigments are known from the prior art. These coatings have a high capacity for light absorption, but at the same time, a high light scattering.

In addition, semitransparent coatings based on organically bound precious metals that have no light scattering are known. Of course, these coatings are very expensive based on the high price of the precious-metal raw materials.

### SUMMARY

The object of the invention is to provide a substrate with an overprinted coating, whereby the coating is semitransparent, has a high scratch resistance, a good temperature stability, and a good adhesion to a sealing layer.

The object is achieved in that the semitransparent coating of the substrate is formed by a coating material that has a sol-gel matrix as well as colorants. In addition, silicone resins functionalized with polyester and/or epoxy, for example, polyester-modified silicone resins, are provided. The coating is applied onto a partially transparent substrate, i.e., onto glass or glass ceramics.

### BRIEF DESCRIPTION OF THE DRAWINGS

FIG. 1 is a scanning electron micrograph of a semitransparent coating according to the present disclosure; and

FIG. 2 is a graph illustrating the transmission of a semitransparent coating according to the present disclosure.

### DETAILED DESCRIPTION

Metal alkoxides, preferably in the form of alkoxysilanes, are used as sol-gel initial materials for the sol-gel matrix. These can be purchased inexpensively as standard products. A tetraalkoxysilane, e.g., tetraethoxysilane (TEOS) in combination with a trialkoxysilane that possesses an organically crosslinkable functionality is preferably always employed. These substances additionally bring about a slight shrinkage upon heating, so that there results a good adhesion to the substrate surface. In order to assure a high crosslinking within the hybrid-polymer sol-gel matrix, among others, alkoxysilanes having the following functionalities are employed: epoxysilanes, acrylic silanes, methacrylic silanes, vinylsilanes or allylsilanes. In this way, depending on how the radicals are adjusted in each case, stable or flexible network structures can be constructed. Suitable, for example, are: glycidoxypropyltriethoxysilane (GPTES), methacryloxypropyltrimethoxysilane (MEMO or MPTMS), methacryloxypropyltriethoxysilane (MPTES) or vinyltriethoxysilane (VTES).

The sol-gel matrix is produced in the form of a hydrolysate. The hydrolysate is produced by the targeted reaction of the monomers with water. This is preferably carried out in the presence of a catalyst, particularly, an acid (e.g., HCl, para-toluenesulfonic acid).

In a special embodiment, the hydrolysis is conducted with an aqueous dispersion of nanoparticles. The scratch resistance is improved by the use of inorganic nanoparticles, preferably SiO₂ nanoparticles.

The inorganic degree of crosslinking of the hydrolysate is adjusted via the water-to-monomer ratio; the inorganic degree of crosslinking here is preferably between 11 and 50%. In this case, a sufficient flexibility is offered for an organic crosslinking. More preferably, the inorganic degree of crosslinking is between 15 and 35%. Since the sol-gel matrix is still not completely gelled throughout thereby, a good durability then results. The coating material is stable for several years. The inorganic degree of crosslinking is determined via ²⁹Si-NMR spectroscopy. The viscosity of the hydrolysate is 200-1,000 mPas. The inorganic degree of crosslinking is small with this viscosity, so that the organic crosslinking can be sufficiently assured. Good durability of the printed coating additionally results, if the viscosity is selected in the range between 250 and 600 mPas. The mean content of residual solution in the hydrolysate is preferably less than 10% in order to obtain a good printability with use as a screen-printing paste.

By addition of one or more polyester-modified silicone resins, a good adhesion of the semitransparent coating onto the sealing layer and at the same time an improvement in the screen-printing capability can be achieved. For example, SILIKOFTAL® products can be used as polyester-modified silicone resins. In addition, other silicone resins, such as SILIKOPHEN®, for example, can be added to the hydrolysate.

Different coloring agents that assure an opaque coating with little light scattering may be used for coloring the layer.

Thus, organic colorants, such as Orasols, for example, may be added to the binding agent. Orasol RLI may be used preferably for a dark or a black coating. In addition, the following are suitable as temperature-stable colorants: azo colorants such as methyl orange, alizarin yellow or Congo red; triphenylmethane colorants such as malachite green, eosin, fluorescein, aurine and phenolphthalein; vat dyes such as anthraquinone colorants, indigo and thioindigo; fluorescent dyes; perylene colorants.

Phthalocyanines with, e.g., Cr, Cu, Ni, Zn or Co as the central atom may also be used. These colorants are particularly suitable for application in the field of printing onto a glass-ceramic cooktop. In particular, these colorants are sufficiently temperature-stable up to 150° C.

High-boiling solvents with a vapor pressure of <5 bars, preferably <1 bar, more preferably <0.1 bar, can be used as solvent. Solvents that have a boiling point of more than 120° C. and an evaporation number of >10 are preferably added. A solvent with a boiling point above 150° C. and an evaporation number of >500 is more preferably used, and a solvent with a boiling point above 200° C. and an evaporation number of >1000 is most preferably used. Such high-boiling solvents are particularly glycols and glycol ethers, terpenes and polyols, as well as mixtures of several of these solvents The following may be used as the solvent: butyl acetate, methoxybutyl acetate, butyl diglycol, butyl diglycol acetate, butyl glycol, butyl glycol acetate, cyclohexanone, diacetone alcohol, diethylene glycol, dipropylene glycol monomethyl ether, dipropylene glycol monobutyl ether, propylene glycol monobutyl ether, propylene glycol mono-propyl ether, propylene glycol monoethyl ether, ethoxypropyl acetate, hexanol, methoxypropyl acetate, monoethylene glycol, ethylpyrrolidone, methylpyrrolidone, dipropylene glycol dimethyl ether, propylene glycol, propylene glycol monomethyl ether, mixtures of paraffinic and naphthenic hydrocarbons, aromatic hydrocarbon mixtures, mixtures of aromatic alkylated hydrocarbons, and mixtures of n-, i- and cyclo-aliphates. Polyethylene glycol ethers, in particular, such as, for example, diethylene glycol monoethyl ether, tripropylene glycol mono-methyl ether, and terpineol, may be used as solvents. The use of solvent mixtures is also possible. Here, the solvents can be added to the sol-gel-based matrix as well as to the coating material.

The use of a high-boiling solvent assures the screen-printing capability of the semitransparent coating material.

The semitransparent coating according to the invention can be well hardened at low temperatures between 100° C. and 230° C., preferably between 150° C. and 200° C. At temperatures below 230° C., it is assured that the sensitive colorants are not broken down. With the use of pre-stressed glass substrates in the layer packet, it is assured by the low hardening temperature of the sealing layer that the pre-stressed glass substrate is not relaxed. The hardening time of the semitransparent coating is between 15 and 120 min, more preferably less than 75 min, and most preferably less than 60 min. This assures a good cycle time in production plants and thus has a direct positive influence on the manufacturing costs of a product.

The inorganic degree of crosslinking of the layers is 11%-40%, preferably 15-35%. The degree of inorganic crosslinking in this case can be determined by the method of NMR spectroscopy, which is known to the person skilled in the art.

In order to initiate the crosslinking reaction of the organic functional groups, heat-activatable initiators can be added to the coating solution. The initiator may be, for example, 1,5-diazobicyclo(4.3.0)non-5-ene, aluminum acetylacetonate or methyl imidazole.

The following UV-activatable initiators for cationic or radical polymerization may also be added, for example, to the coating solution: triarylsulfonium salts, diaryliodinium salts (e.g. Irgacure 250), ferrocenium salts, benzoin derivatives, a-hydroxyalkylphenones (e.g. Irgacure 184), a-aminoacetophenones (e.g. 2-methyl-1[4-(methylthio)phenyl] 2-morpholinopropanones) or acyl phosphine oxides (e.g. Irgacure 819).

In order to increase the scratch resistance, organic hardeners or crosslinkers having several organic crosslinkable groups, such as bis(epoxide), bis(methacrylate), or the like, can be added to the coating material.

The molar ratio of crosslinkable organosilanes to monomer in the hardener or crosslinker used can be 35:1-10:1. In this case, a degree of organic crosslinking can be achieved, in which flexibility and hardness of the coating are well balanced. For a rapid hardening, the molar ratio can preferably amount to 25:1-15:1. The hardener or crosslinker in this case can be, e.g., (3,4-epoxycyclomethyl) 3,4-epoxycyclohexanecarboxylate.

Various leveling agents, defoamers, deaerators or dispersing agents, such as, for example, PEG, BYK 302, BYK 306, BYK 307, DC11, DC57 or Airex 931 and Airex 930, each time depending on the coating method, may also be added, in order to obtain homogeneous layer thicknesses and a homogeneous distribution of color in the coating.

In a special embodiment according to the invention, adhesion promoters can be added to the coating. These can be, for example, aminosilanes and/or mercaptosilanes; e.g., the promoter can be 3-aminopropyltriethoxysilane or 3-mercaptopropyltriethoxysilane. The proportion of adhesion promoter silanes in this case can be between 1:100 and 1:10, preferably between 1:50 and 1:15, referred to the other alkoxysilanes.

The coating material can be applied by a printing method. This printing method can be an ink-jet printing, offset printing, pad printing, roll coating, dipping, spin coating, or spray method. Preferably, the coating material is introduced onto the substrate by means of screen printing.

Glass or glass ceramics are used as the substrate according to the invention. Particularly preferred, glass ceramics are used as the substrate. The substrate may also be pre-coated.

Preferably, an LAS (lithium-aluminum-silicate glass ceramics: Li₂O—Al₂O₃—SiO₂) containing high-quartz mixed crystals and/or keatite mixed crystals is used as the predominant crystal phase. Preferably, LAS glass ceramics containing TiO₂, and/or ZrO₂, and/or SnO₂ are used as nucleating agents.

The substrates used preferably contain less than 1000 ppm, more preferably less than 500 ppm, and most preferably, less than 200 ppm arsenic and/or antimony. In one embodiment, the transparent glass ceramics used are devoid of arsenic and antimony.

The content of crystal phase in the glass-ceramic panels preferably amounts to 50-85%, more preferably 60-80%, most particularly 64-77%.

In order to obtain the necessary strength values, the preferred thickness of the glass-ceramic panel amounts to 0.8-6 mm, preferably 2.5-5 mm, more preferably 3.5-4.5 mm.

According to the invention, the semitransparent coating material can be produced from a mixture of a first component mixture and a second component mixture as a one-component or several-component lacquer, which is capable of being screen-printed, and particularly as a 2-component lacquer based on hybrid polymers, wherein the sol-gel binder as well as the remaining crosslinking components are present separately from the initiator.

The organic dyes in this case can be added to both the first as well as the second component.

The scratch resistance of the layers is 400 g. The scratch resistance was determined by a Scratch Hardness Tester 413 of the Erichsen company. A tungsten carbide tip with a diameter of 1 mm was used as the measurement tip.

The viscosity of the dark semitransparent colorant, particularly the thixotropic behavior for the screen-printing method, can be adapted, via the content of solvent, to the content of polyester-modified silicone resin or, by variation of additives, to the selected printing method, prior to printing. The viscosity of screen-printable lacquers according to the invention preferably lies at 200 mPa*s-1000 mPa*s, more preferably at 250-600 mPa*s.

The mean layer thicknesses of the especially dark semitransparent coating lies in the range between 1 and 20 μm, preferably between 4 and 10 μm, more preferably between 4 and 8 μm. Layer thicknesses in the range between 4 and 10 μm can be achieved with familiar colorants without anything further, while layer thicknesses in the range between 4 and 7 μm can be achieved with colorants having higher light transmittance (particularly suitable for LED application).

The transmission of the coating according to the invention in the wavelength region of 380-630 nm can lie between 0 and 20%, preferably between 0 and 10%. So, in this case, commercial LEDs with sufficiently high light output on the display side can be employed. The transmission of the dark coating increases up to 90% in the wavelength region of 630-790 nm.

The L*a*b values of the dark semitransparent coating lie in the range of L=22−27, a=−1.0 to 1.0, b=−2.0 to −0.5.

The L*a*b values of the bright semitransparent coating lie in the range of L=60−90, a=−1.5 to −1.0, b=5.0 to 8.0.

In principle, it is possible according to the invention to approximate any color coordinates by a targeted selection of the coloring agent and working this coloring agent into the sol-gel binder and subsequent coating a substrate with the sol-gel color.

The light scattering within the dark semitransparent coating lies in the range of 0-3.5%, preferably 0-2.5%. The light scattering within the bright semitransparent coating lies in the range of 5-85%, preferably 10-75%. These values are determined by a haze measurement known to the person skilled in the art.

### EXAMPLE OF EMBODIMENT 1 (1-COMPONENT SYSTEM)

0.08 mole of GPTES (glycidyloxypropyltriethoxysilane) and 0.02 mole of TEOS (tetraethoxysilane) are hydrolyzed with water mixed with 0.02 mole of para-toluenesulfonic acid.

Subsequently, the solvent is removed in the rotary evaporator and 23.0 g of binder are obtained.

12.5 g of polyester-modified silicone Silikoftal HTT, 0.50 g of silicone epoxy resin Silikopon EF, 4.60 g of (3,4-epoxycyclomethyl) 3,4-epoxycyclohexanecarboxylate, 5.00 g of colorant Orasol RLI, 0.50 g of Airex 931, 0.10 g of BYK 307, and 0.20 g of DC11 are added to the 23.0 g of this binder.

The solution is stirred for 5 min in the SpeedMixer.

After complete mixing of the solution, a 3-5-μm thick layer is applied onto transparent glass ceramics by means of screen printing using a 180-mesh screen. This layer is hardened for 1 h at 170° C.

### EXAMPLE OF EMBODIMENT 2 (2-COMPONENT SYSTEM)

First component:

0.08 mole of GPTES (glycidyloxypropyltriethoxysilane) and 0.02 mole of TEOS (tetraethoxysilane) are hydrolyzed with water mixed with 0.02 mole of para-toluenesulfonic acid. Subsequently, the solvent is removed in the rotary evaporator and 23.0 g of binder are obtained.

4.60 g of (3,4-epoxycyclomethyl) 3,4-epoxycyclohexanecarboxylate, 5.00 g of colorant Orasol RLI, 0.50 g of Airex 931, 23.0 g of diethylene glycol monoethyl ether, 0.10 g of BYK 307 and 0.20 g of DC11 are added to the 23.0 g of this binder. The solution is stirred for 5 min in the SpeedMixer.

Second component:

12.5 g of silicone polyester resin Silikoftal HTT, 0.50 g of silicone epoxy resin Silikopon EF, and 4.90 g of methylimidazole are mixed and stirred for 10 minutes.

Prior to applying the color onto the substrate, both components are mixed for 5 minutes with intense stirring. A 3-5-μm thick layer is applied onto transparent glass ceramics by means of screen printing using a 180-mesh screen. This layer is hardened for 1 h at 170° C.

### EXAMPLE OF EMBODIMENT 3 (2-COMPONENT SYSTEM)

First component:

0.08 mole of GPTES (glycidyloxypropyltriethoxysilane) and 0.02 mole of TEOS (tetraethoxysilane) are hydrolyzed with water mixed with 0.02 mole of para-toluenesulfonic acid. Subsequently, the solvent is removed in the rotary evaporator and 23.0 g of binder are obtained.

12.5 g of silicone polyester resin Silikoftal HTT, 0.50 g of silicone epoxy resin Silikopon EF, 4.60 g of (3,4-epoxycyclomethyl) 3,4-epoxycyclohexane carboxylate, 5.00 g of colorant Orasol RLI, 0.50 g of Airex 931, 23.0 g of diethylene glycol monoethyl ether, 0.10 g of BYK 307 and 0.20 g of DC11 are added to the 23.0 g of this binder. The solution is stirred for 5 min in the SpeedMixer.

Second component:

4.90 g of methylimidazole

Prior to applying the color onto the substrate, both components are mixed for 5 minutes with intense stirring. A 3-5-μm thick layer is applied onto transparent glass ceramics by means of screen printing using a 180-mesh screen. This layer is hardened for 1 h at 170° C.

### EXAMPLE OF EMBODIMENT 4

Instead of the colorant Orasol RLI employed in Examples of embodiment 1, 2, and 3, in the case of Example of embodiment 4, 4.00 g of Orasol RLI and 1.00 g of Orasol yellow are employed.

### EXAMPLES OF EMBODIMENT 5 and 6

Instead of the silicone polyester resin Silikoftal HTT employed in Examples of embodiment 1, 2, and 3, in the case of Example of embodiment 5, Silikoftal HTL, and in the case of Example of embodiment 6, Silikoftal HTL-2 are employed.

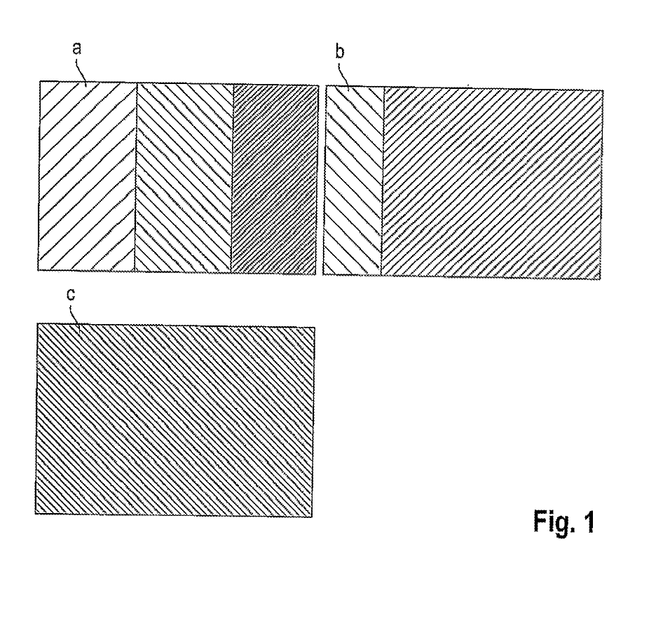

In the appended FIG. 1, a scanning electron micrograph of a semitransparent coating on glass ceramics colored with Orasol RLI and having a mean layer thickness of 5 μm is shown. The region in the diagram denoted by a shows a 20,000 magnification, the region denoted by b shows a 50,000 magnification, and the region denoted by c shows a 200,000 magnification.

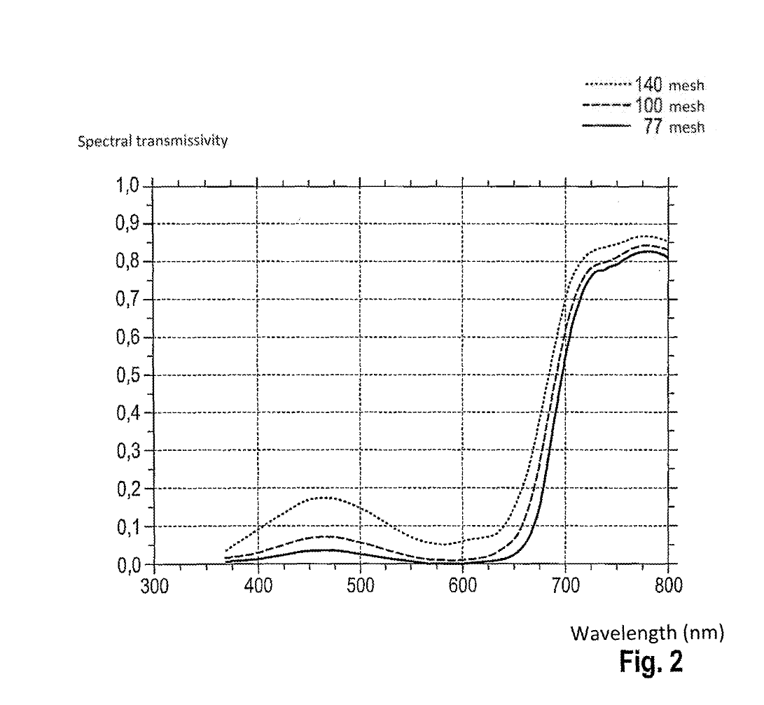

The transmission of a semitransparent coating colored with Orasol RLI on glass ceramics is shown in FIG. 2 as a function of the employed screen mesh of a screen-printing device. In this case, a 77-mesh, a 100-mesh and a 140-mesh screen are shown.

What is claimed is:

1. A coated substrate, comprising:
a substrate of glass or glass ceramics that is at least partially transparent; and
a semitransparent coating on the substrate, the semitransparent coating comprising a coating material having a sol-gel matrix, colorants, and silicone resin functionalized with polyester and/or epoxy.

2. The coated substrate according to claim 1, wherein the silicone resins functionalized with polyester and/or epoxy comprise polyester-modified silicone resin

3. The coated substrate according to claim 1, wherein the sol-gel matrix is formed from a precursor comprising a metal alkoxide.

4. The coated substrate according to claim 3, wherein the precursor comprises alkoxysilane.

5. The coated substrate according to claim 4, wherein the alkoxysilane has an organically crosslinkable functionality.

6. The coated substrate according to claim 4, wherein the alkoxysilane is selected from the group consisting of epoxysilane, acrylic silane, methacrylic silane, vinylsilane, allylsilane, and combinations thereof.

7. The coated substrate according to claim 3, wherein the precursor comprises tetraalkoxysilane.

8. The coated substrate according to claim 3, wherein the precursor comprises a mixture of tetraethoxysilane and trialkoxysilane.

9. The coated substrate according to claim 3, wherein the colorants are selected from the group consisting of: Orasol, Orasol RLI, azo colorants, methyl orange, alizarin yellow, Congo red, triphenylmethane colorant, malachite green, eosin, fluorescein, aurine, phenolphthalein, vat dyes, anthraquinone colorants, indigo, thioindigo, fluorescent dye, perylene colorant, phthalocanine, and combinations thereof.

10. The coated substrate according to claim 1, wherein the semitransparent coating further comprises organic hardeners and/or crosslinkers that have several organically crosslinkable groups.

11. The coated substrate according to claim 10, wherein the semitransparent coating further comprises wherein bis(epoxide) and/or bis(methacrylate).

12. The coated substrate according to claim 10, wherein the semitransparent coating has a molar ratio of crosslinkable organosilanes to monomer in the hardener and/or crosslinker is in a range between 35:1 and 10:1.

13. The coated substrate according to claim 10, wherein the molar ratio is in a range between 25:1 and 15:1.

14. The coated substrate according to claim 1, wherein the sol-gel matrix has both an inorganic and an organic crosslink.

15. The coated substrate according to claim 1, wherein the silicone resins are functionalized with halogens and/or organic groups.

16. The coated substrate according to claim 1, wherein the silicone resins are functionalized with with a component selected from the group consisting of alkanes, alkenes, aromatic compounds, aldehydes, ketones, ethers, and combinations thereof.

17. The coated substrate according to claim 1, wherein the silicone resin has at least one phenyl group and/or vinyl group.

18. The coated substrate according to claim 1, wherein the semitransparent coating has a mean layer thickness of between 1 and 20 μm.

19. The coated substrate according to claim 1, further comprising a transmission in the wavelength region of 380 nm-630 nm that lies between 0% and 20%.

20. The coated substrate according to claim 19, wherein the transmission lies between 0% and 10%.

21. The coated substrate according to claim 1, wherein the semitransparent coating has an L*a*b value when observed through the substrate that is in the range of L=22−27, a=−1.0 to 1.0; b=−2.0 to −0.5.

22. The coated substrate according to claim 1, wherein the semitransparent coating has an L*a*b value when observed through the substrate that is in the range of L=60−90, a=−1.5 to −1.0; b=5.0 to 8.0.

23. The coated substrate according to claim 1, wherein the semitransparent coating has a light scattering that is in the range between 0 and 3.5%

24. The coated substrate according to claim 1, wherein the semitransparent coating has a light scattering that is in the range between 5 and 85%.
